(19) United States
(12) Patent Application Publication
(10) Pub. No.: US 2002/0057206 A1
(43) Pub. Date: May 16, 2002

(54) METHOD AND APPPARATUS FOR AN IMPROVED REMOTELY SWITCHABLE POWER SUPPLY

(76) Inventor: CHARLES H. REYNOLDS, GILROY, CA (US)

Correspondence Address: MAJESTIC PARSONS SIEBERT & HSUE, SUITE 1100, FOUR EMBARCADERO CENTER, SAN FRANCISCO, CA, 94111-4106, US

(21) Appl. No.: 09/471,101

(22) Filed: Dec. 21, 1999

Related U.S. Application Data
(63) Continuation-in-part of application No. 09/309,321, filed on May 11, 1999.

(51) Int. Cl. H04Q 1/00

(52) U.S. Cl. 340/825; 340/693.1; 713/300

(57) ABSTRACT

In one embodiment, one or more controlled power outlets placed on a power supply housing having the desirable characteristic that the height of the housing allows it to be mounted in a standard network device rack occupying one rack unit. In various embodiments, one or more power sockets may be provided, and one or more power sockets may be controlled by signals received on each control socket.

### CROSS REFERENCE TO RELATED APPLICATIONS

This application is a continuation in part of METHOD AND APPARATUS FOR A REMOTELY SWITCHABLE POWER SUPPLY, No. 09/309,321 filed May 11, 1999.

This application is related to the following design applications, each by the same inventor, each of which is incorporated by reference, and each of which was filed on the same day as this application:

REMOTELY SWITCHABLE POWER SUPPLY FOR NETWORK DEVICE RACKS HAVING PORTS AND OUTLETS ON ONE SURFACE;

REMOTELY SWITCHABLE POWER SUPPLY FOR NETWORK DEVICE RACKS HAVING 16 NETWORK PORTS AND FOUR POWER OUTLETS; and

REMOTELY SWITCHABLE POWER SUPPLY FOR NETWORK DEVICE RACKS HAVING NETWORK PORTS AND POWER OUTLETS ON DIFFERENT SURFACES.

This application is related to the following previously filed design applications by the same inventor, each of which is incorporated by reference:

REMOTELY SWITCHABLE POWER SUPPLY FOR NETWORK DEVICE RACKS HAVING EIGHT NETWORK PORTS AND FOUR POWER OUTLETS; No. 29/104,720 filed May 11, 1999;

NETWORK REMOTELY SWITCHABLE POWER SUPPLY; No. 29/104,765, filed May 11, 1999;

NETWORK PORT AND POWER OUTLET PLACED ON A SWITCHABLE POWER SUPPLY; No. 29/104,72 filed May 11, 1999.

### FIELD OF THE INVENTION

The present invention is related to the field of electronic circuits and controllable power supplies therefore.

### BACKGROUND OF THE INVENTION

Early in the development of modem networking equipment such as routers, it was realized that at times a particular piece of network equipment might hang or “crash.” In such instances, a human operator often had to intervene by traveling to the location of the equipment and rebooting or power cycling the equipment in order to get that particular piece of equipment working.

Responding to these needs, the inventor of the present invention, as early as 1994, constructed a “power cycle box.” The original design contained two network ports and a control relay connected to at least one power outlet. From the exterior, the supply arranged two network socket connections and a power outlet socket on the same surface of the power supply (the front or the top), and in some instances included an indicator light. A diagram of such a design is shown in FIG. 1. In this design, a particular network signal could be sent through the two network ports which would cause the control relay to disconnect the power supply from the power outlet, thereby, shutting off power to the controlled network device. Another signal would reestablish power, thereby, causing the controlled device to reboot. An alternative design arranged more than one controlled power supply socket with corresponding network sockets on a surface of the power supply. Typically, in this earlier design, some a network signal had to be present through the connectors for the power outlets to be on.

While this design proved both useful and successful in the marketplace, for many years a need has been felt for a more compact and streamlined design that could be fitted efficiently into a standard network rack. However, it is difficult to construct such a design because of the restrictions on placement of elements within the control circuit, which must be sufficiently far apart to provide clearance between the network data connections and the AC power connections to prevent electromagnetic interference. An additional desired feature was for multiple controlled power supplies.

What is needed, therefore, is a power cycle control circuitry that can fit into a small space such as a single rack unit, while allowing for control of multiple power outlets.

It has further been discovered that in some applications there is a need for all power and network sockets to be on the same side of rack-sized unit. It has further been discovered that in some applications, it is desired that a controllable power supply be in a default closed position so that absent a control signal, power will remain on. What is needed, therefore, is a power cycle control circuitry that can meet these additional needs.

It has further been discovered that networking and similar computer systems are employed in a wide variety of locations with a wide variety of available public power configurations using different connectors for both input or output power and in some cases for network communications. What is further needed, therefore, is a power cycle control circuitry adaptable to different systems.

### SUMMARY

According to the invention, one or more controlled power outlets are housed in a power supply housing, the housing having the desirable characteristic that the height of the housing allows it to be mounted in a standard network device rack occupying one rack unit.

In one embodiment, to accomplish this configuration, controlled power outlets are distributed on one surface of the housing, and sockets for receiving a control signal are distributed on a different surface.

In a further embodiment, where it is desirable to have all outlets on one surface, possible to align them with a particular piece of controlled equipment, controlled power outlets and sockets are distributed on a single surface, but in such a way as to prevent electrical interference with network signals.

In various embodiments, one or more independently controlled power sockets may be provided, and one or more power sockets may be controlled by each control signal socket.

In a further embodiment, power into the controlled power supply is delivered via a detachable power cord. The detachable power cord has one end that attaches into the power socket and a different end that attaches into an outside power supply, such as a wall outlet. Thus, a controlled power supply according to this embodiment may be used with a variety of different available plug configurations, such as different outlets commonly provided in the U.S. versus European countries.

In a further embodiment, the circuitry in a power supply can operate with a range of different incoming supply voltages and currents and provide a controlled supply output at the available voltage or current.

Various embodiments of the invention provide different configurations of, such as supplies with one independently controlled supply outlet circuit, with two circuits, with four circuits, with eight circuits, or with some other number of circuits that can be mounted in the available space. In each case, a pair of network connectors is provided for each independently controlled outlet (or group of outlets) and a network signal is routed through the connectors to provide a control signal. In various embodiments, where space permits, more than one outlet may be supplied for a single control signal pair, but in such cases, power in that outlet is controlled by the same network signal.

A further understanding of the invention can be had from the detailed discussion of specific embodiments below. For purposes of clarity, this discussion refers to devices, methods, and concepts in terms of specific examples. However, the method of the present invention may operate with a wide variety of types of connection sockets for network signals or power. It is therefore intended that the invention not be limited except as provided in the attached claims.

The inventor has prepared a several marketing circulars with photographs and diagrams of specific embodiments of the invention. These documents are filed with the accompanying IDS and incorporated herein by reference.

All publications, patents, and patent applications cited herein are hereby incorporated by reference in their entirety for all purposes. The invention will be better understood with reference to the following drawings and detailed description.

### BRIEF DESCRIPTION OF THE DRAWINGS

FIG. 1 is a block diagram of a housing and controlled power supply according to the prior art.

FIGS. 2A-C is a diagram showing a front view, top view, and side view, of a power supply according to specific embodiments of the invention wherein the power supply has control sockets and power sockets on the same surface.

FIG. 3 illustrates rear views of four alternative embodiments of a power supply according to specific embodiments of the invention, wherein each alternative includes at least one pair of control signal sockets 100 and 102, at least one power input connection 140, and at least one controlled power output 150. One difference in embodiments is the shape and configuration of different connection sockets.

FIGS. 4A-B is a diagram showing a top plane view and front view of a power supply according to specific embodiments of the invention wherein the power supply has four independent pairs of control sockets.

FIG. 5 illustrates rear views of four alternative embodiments of a power supply according to specific embodiments of the invention, wherein each alternative includes at least one power input connection 140 and four independently controlled power outputs 150. One difference in embodiments is the shape and configuration of different connection sockets.

FIGS. 6A-B is a diagram showing a top plane view and front view of a power supply according to specific embodiments of the invention wherein the power supply has eight independent pairs of control sockets.

FIG. 7 illustrates rear views of three alternative embodiments of a power supply according to specific embodiments of the invention, wherein each alternative includes at least one power input connection 140 and eight independently controlled power outputs 150. One difference in embodiments is the shape and configuration of different connection sockets.

FIGS. 8A-C show alternative top plane views of a power supply according to alternative specific embodiments of the invention wherein there are two pair of control sockets and two controlled outputs with various possible arrangements of control signal sockets and controlled outputs.

FIG. 9 is a simplified block diagram showing functional elements of one specific embodiment of the present invention for one controlled circuit.

FIG. 10 shows four alternative wiring diagrams of a power supply according to specific embodiments of the invention, wherein each alternative includes one pair of control signal sockets 100 and 102, a power input connection 140, and dual commonly-controlled power outputs 150.

FIG. 11 shows four alternative wiring diagrams of a power supply according to specific embodiments of the invention, wherein each alternative includes two pairs of control signal sockets 100 and 102, a power input connection 140, and two independently-controlled power outputs 150.

FIGS. 12A-B show four alternative wiring diagrams of a power supply according to specific embodiments of the invention, wherein each alternative includes four pairs of control signal sockets 100 and 102, two power input connections 140, and four independently-controlled power outputs 150.

FIGS. 13 shows two alternative wiring diagrams of a power supply according to specific embodiments of the invention, wherein each alternative includes eight pairs of control signal sockets 100 and 102, two power input connections 140, and eight independently-controlled power outputs 150.

FIG. 14 shows two alternative wiring diagrams of a power supply according to specific embodiments of the invention, wherein each alternative includes two pairs of control signal sockets, two power input connections, and two independently-controlled power outputs.

FIGS. 15A-C show alternative top plane views of a alternative power supply wherein there are three independent control sockets and three controlled outputs with various possible arrangements of control signal sockets and controlled outputs.

FIG. 16 shows a wiring diagram of a alternate power supply including three control signal sockets, a power input connection, and three independently-controlled power outputs.

### DESCRIPTION OF THE SPECIFIC EMBODIMENTS

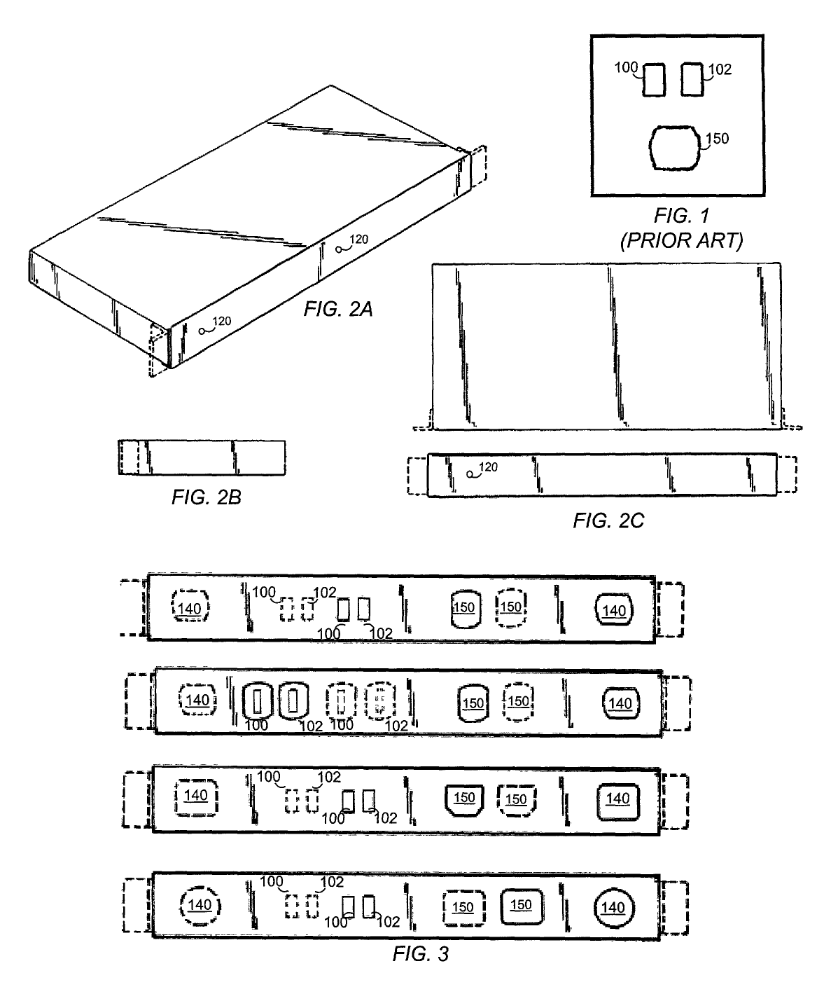

According to the invention, one or more controlled power supplies can be housed in a power supply housing as shown in Figs. FIG. 1 through FIG. 7. In one embodiment, the housings shown the figures has the desirable characteristic that the height (h) of the housing is such that the housing can be mounted in a standard network device rack and will occupy only one rack unit. As is known in the art, one rack unit in one well-known device standard is 1.75 inches.

FIGS. 2A-C is a diagram showing a front view, top view, and side view, of a power supply according to specific embodiments of the invention wherein the power supply has control sockets and power sockets on the same surface. As can be seen from the figure, in this embodiment, the invention is a box shape for mounting in a computer system or network device rack. One or more optional indicators 120 may be placed on a visually accessible an convenient location, such as the front, to indicate a power status of a box, with, for example, a lit indicator indicating that power is active to a socket 150.

FIG. 3 illustrates rear views of four alternative embodiments of a power supply according to specific embodiments of the invention, wherein each alternative includes at least one pair of control signal sockets 100 and 102, at least one power input connection 140, and at least one controlled power output 150. One difference in embodiments is the shape and configuration of different connection sockets. As is known in the art, a wide variety of different connector shapes and configurations are possible. FIG. 3 shows three different possible shapes for power input socket 140, which may be attached to a power supply by various detachable power cords having a variety of “wall” plugs for use in different power systems. Two different configurations are shown for network connectors 100 and 102. Three different possible configurations are shown for power outlet plug 150. It will be understood in the art that a wide variety of different configurations of sockets are possible according to the invention, as appropriate for different applications.

According to a further aspect, the various sockets shown in FIG. 3 may be arranged so as to reduce any possible electrical interference and provide proper clearances within the housing while also aligning appropriately to match plugs and connections on a controlled device, such as a network router. In a further embodiment, network and power ports are arranged on one surface of the controller to correspond to their position on particular popular network devices, such as a Cisco® brand router, to allow for easy patching with the router connections.

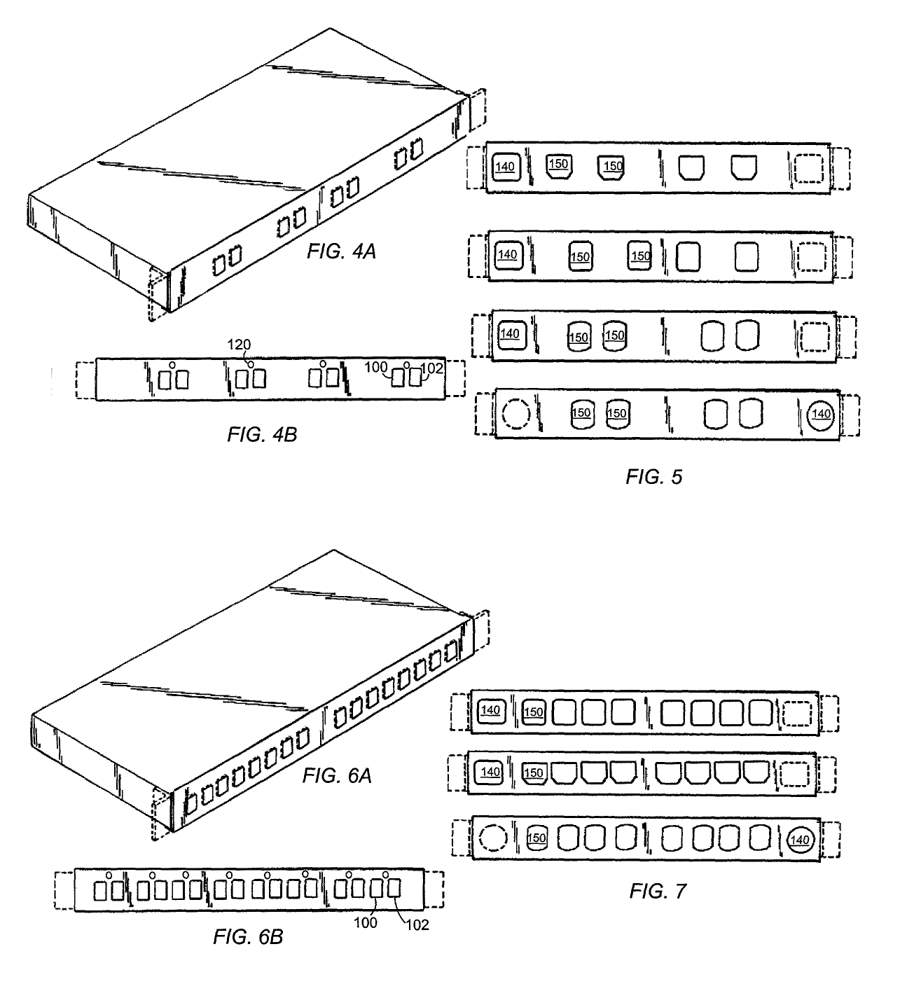

FIGS. 4A-B is a diagram showing a top plane view and front view of a power supply according to specific embodiments of the invention wherein the power supply has four independent pairs of control sockets. It will be understood that although just one shape for sockets 100 and 102 is shown, the invention in various figures herein can include any known configuration of a network socket connection and can include different configurations on the same power supply when so desired. An optional indicator 120 can be associated with each pair of signal sockets.

FIG. 5 illustrates rear views of four alternative embodiments of a power supply according to specific embodiments of the invention, wherein each alternative includes at least one power input connection 140 and four independently controlled power outputs 150. One difference in embodiments is the shape and configuration of different connection sockets. It will be understood that a second power connection 140 (shown in dashed lines) may be included to bring additional power into the controlled box. Input connection sockets 140 and output controlled supply sockets 150 can comprise any shape of power socket connection and can include different shapes on the same power supply when so desired.

FIGS. 6A-B is a diagram showing a top plane view and front view of a power supply according to specific embodiments of the invention wherein the power supply has eight independent pairs of control sockets. As in FIGS. 4A-B, variations in shape of socket connections and mixtures of socket connections are possible.

FIG. 7 illustrates rear views of three alternative embodiments of a power supply according to specific embodiments of the invention, wherein each alternative includes at least one power input connection 140 and eight independently controlled power outputs 150. One difference in embodiments is the shape and configuration of different connection sockets.

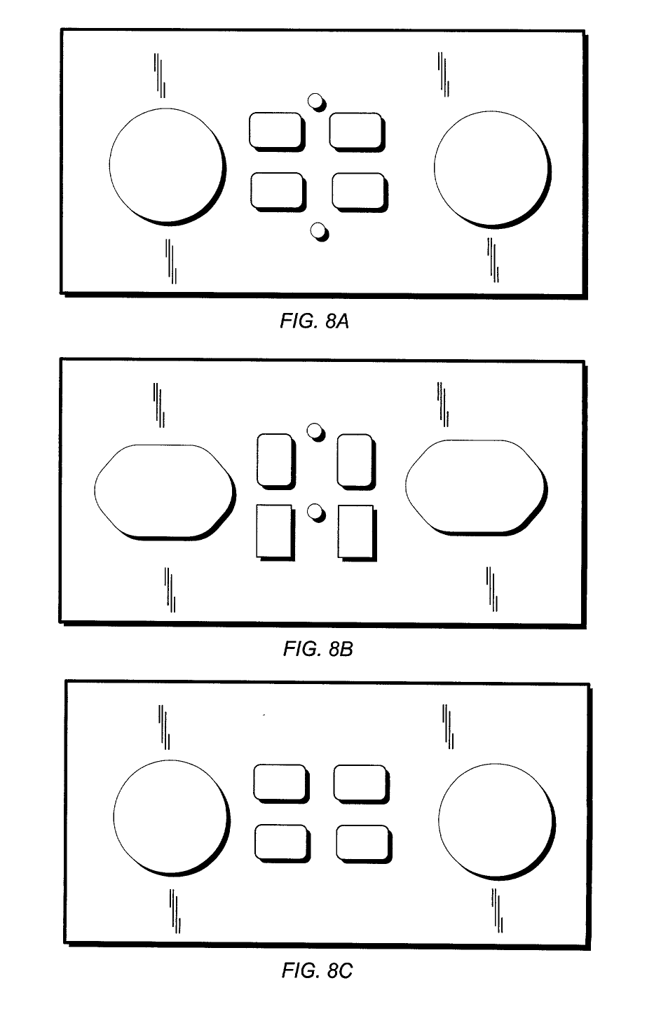

FIGS. 8A-C show alternative top plane views of a power supply according to alternative specific embodiments of the invention wherein there are two pair of control sockets and two controlled outputs with various possible arrangements of control signal sockets and controlled outputs.

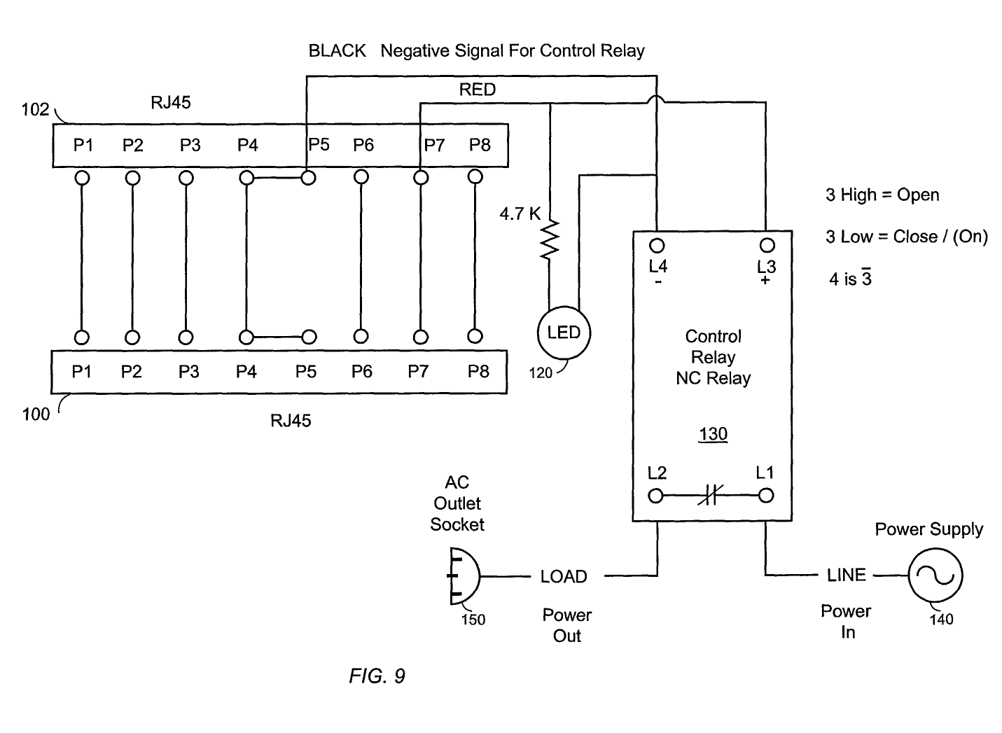

FIG. 9 is a simplified block diagram showing functional elements of one specific embodiment of the present invention with an example of one controlled circuit. Shown are control sockets 100 and 102 (which in one specific embodiment may be standard RJ45 network sockets having pins as shown, but in other embodiments can include any type of network or communication connector), indicator 120 (which may be an LED), control relay 130. According to one embodiment of the invention, a network connection is made through sockets or receptacles 100 and 102 and in standard network data transmission, data passes through the connections without being affected by the circuits of the invention.

However, when a controlling network device such as a router wishes to cause a power cycle to the load connected to AC outlet 150, the controlling network device places a predefined signal on pin 7 and alternatively also on pin 4 or 5. The signal from pin 7 connects to pin 3, which when forced to the low state causes control relay 130 to open thereby disconnecting the power supply line from the load line and removing power from AC outlet 150. At the same time, according to one embodiment of the invention, an opposite signal is placed on pins 4 or 5 causing control relay L4 to go to a high state which also forces control relay 130 to disconnect the power supply line from the loaded AC outlet.

LED 120 is an optional indicator light that may be variously connected to indicate when outlet 150 is on or off.

In the embodiment described above, control relay 130 is normally in the closed position connecting the power supply line to the load line, and a specific signal on a pin of the sockets must be asserted to open the relay and thereby disconnect the power supply.

In an alternative embodiment, control relay 130 is normally in the open position disconnecting the power supply line from the load line, and a specific signal on a pin of the sockets must be asserted to close the relay and thereby connect the power supply.

One advantage of the current invention is that a control signal for the power supply is generated as a standard network signal and does not require a separate communication interface with the controlled network device, such as an RS232 connection. The control signal for AC outlet 150 could also be delivered through a single control socket such as 102. However, this is a less desirable alternative because it would require a dedicated line from the controlling network device to the power supply, rather than the pass-through network connection.

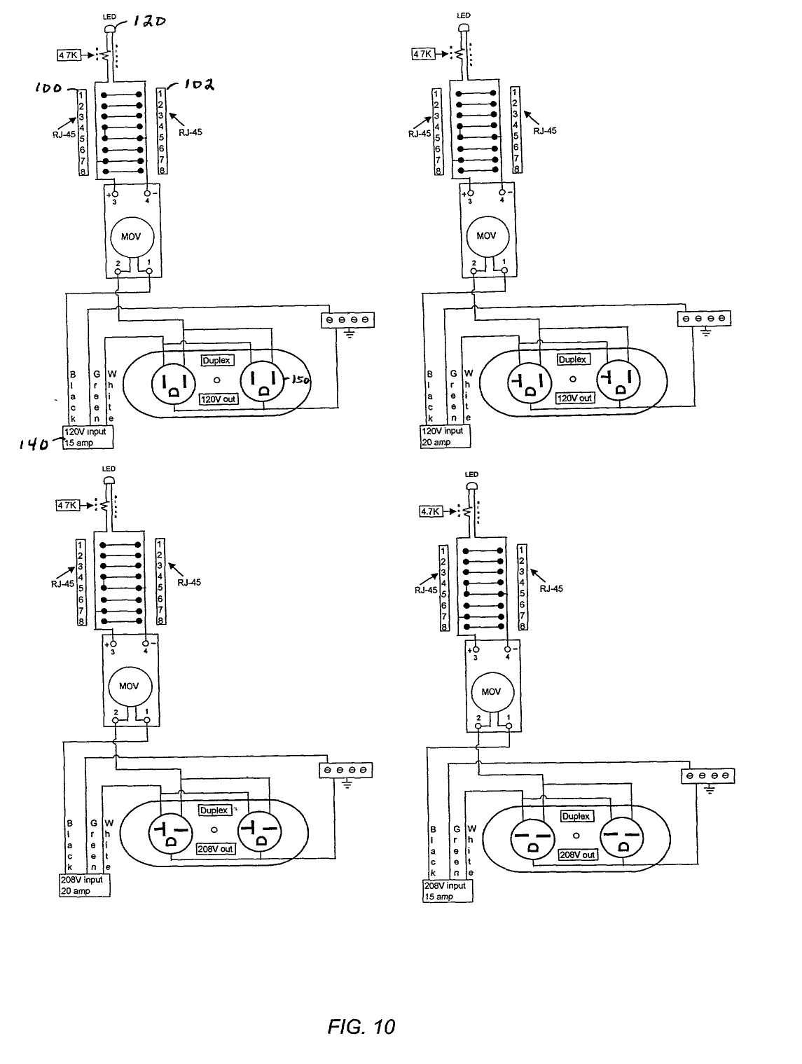

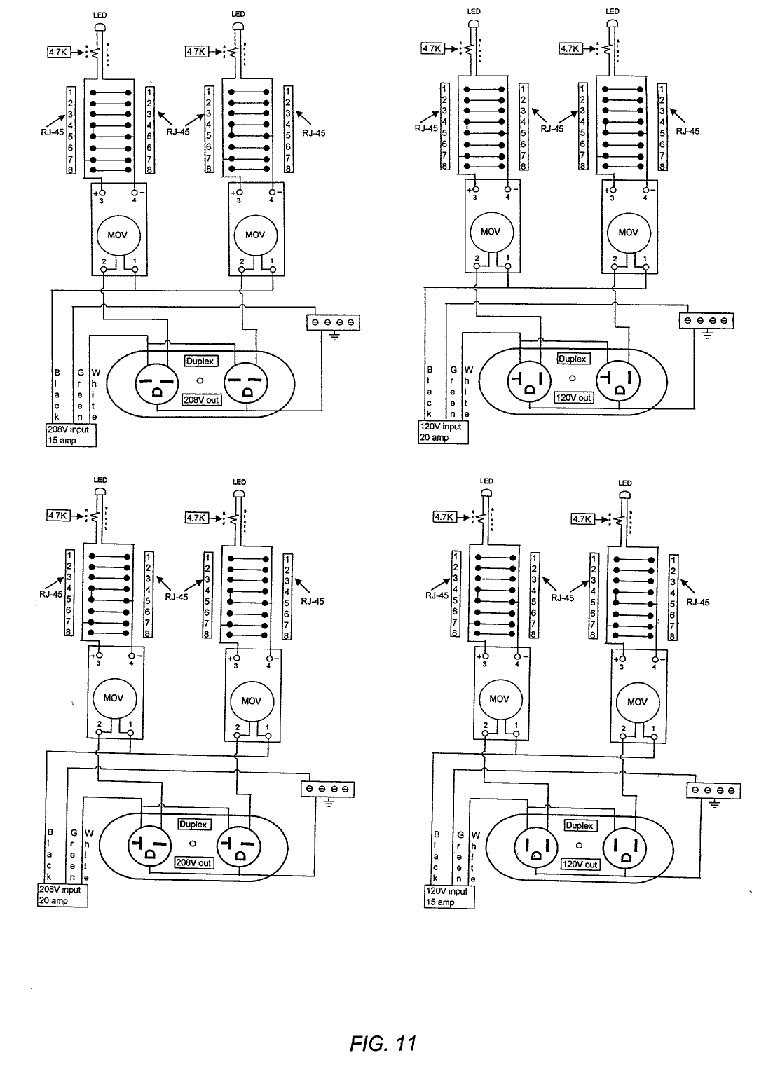

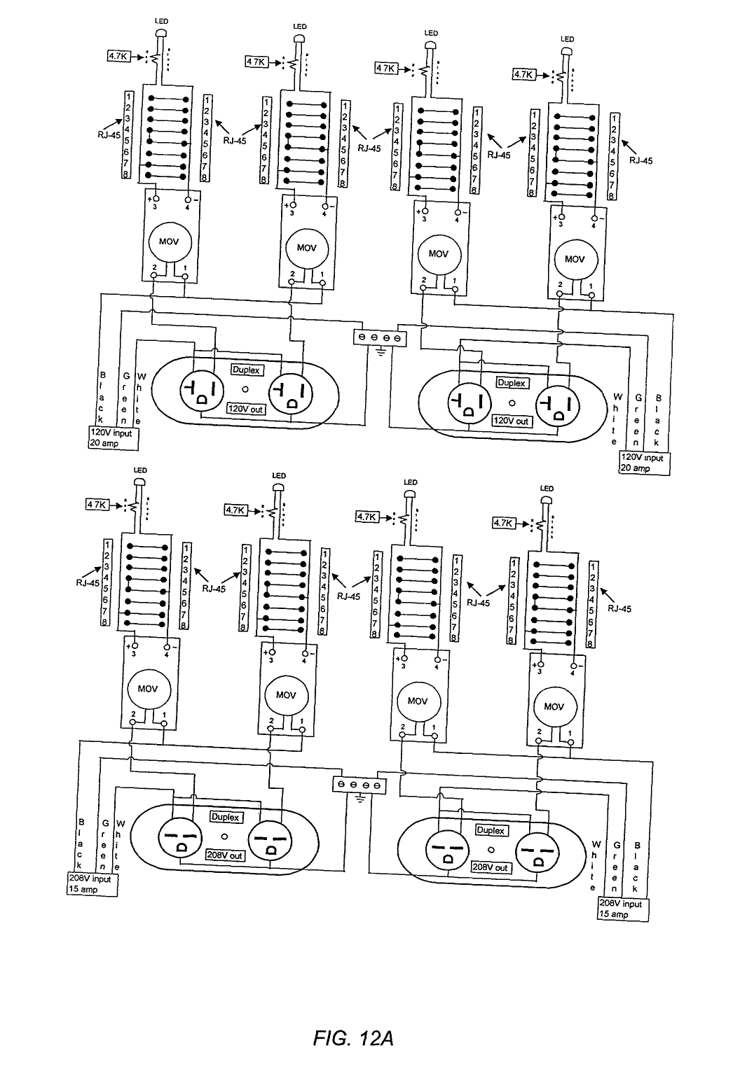

FIG. 10 shows four alternative wiring diagrams of a power supply according to specific embodiments of the invention, wherein each alternative includes one pair of control signal sockets 100 and 102, a power input connection 140, and dual commonly-controlled power outputs 150.

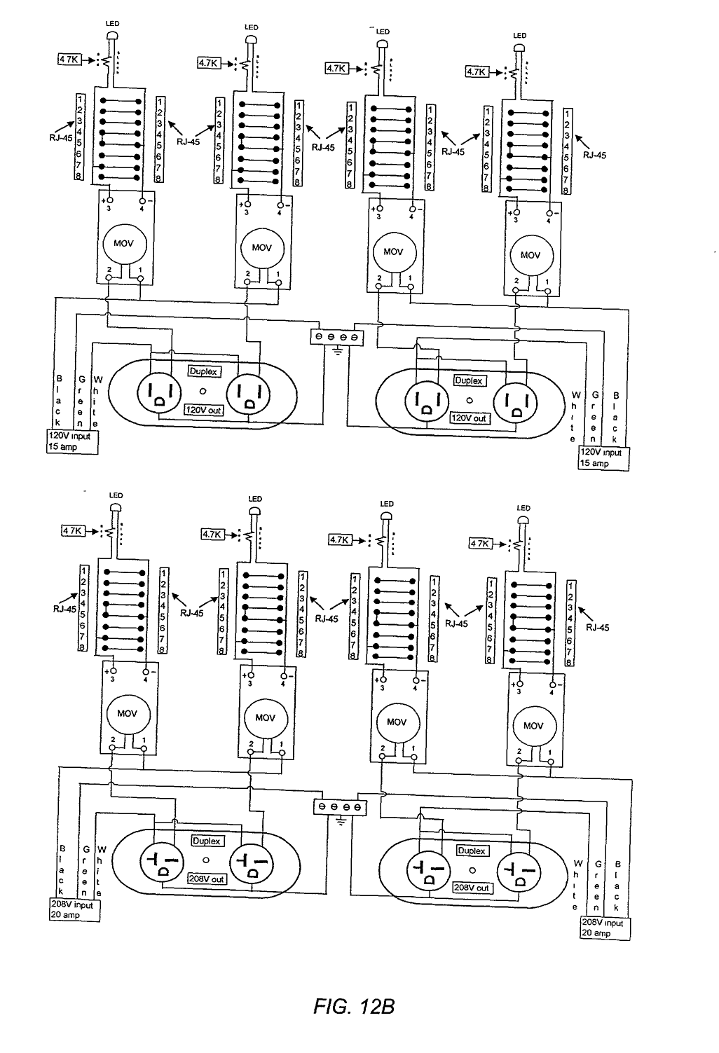

FIG. 11 shows four alternative wiring diagrams of a power supply according to specific embodiments of the invention, wherein each alternative includes two pairs of control signal sockets 100 and 102, a power input connection 140, and two independently-controlled power outputs 150.

FIGS. 12A-B show four alternative wiring diagrams of a power supply according to specific embodiments of the invention, wherein each alternative includes four pairs of control signal sockets 100 and 102, two power input connections 140, and four independently-controlled power outputs 150.

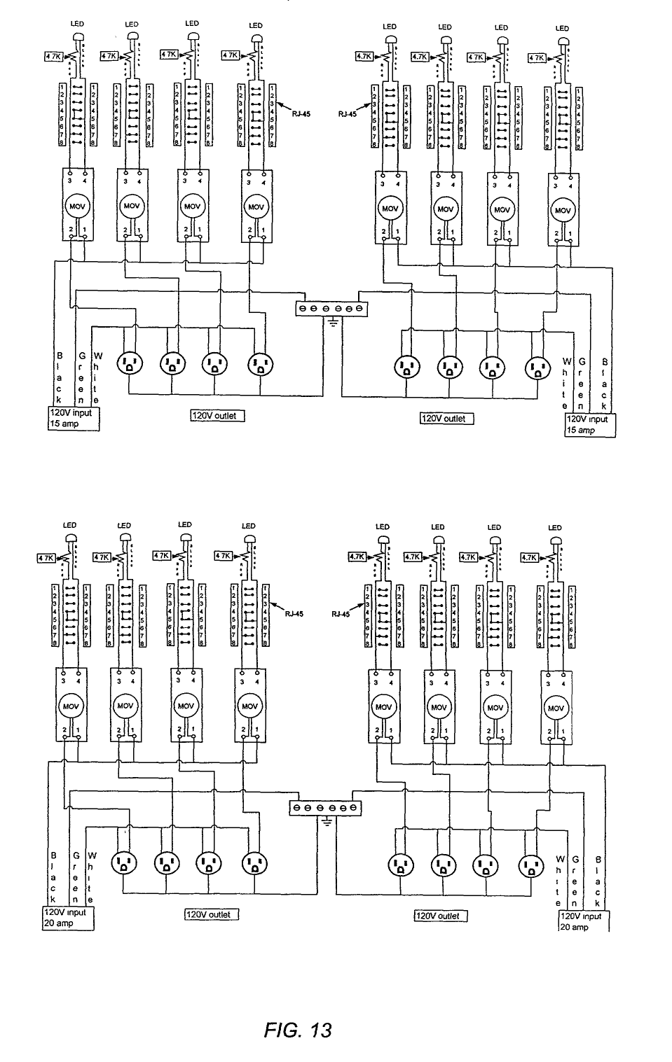

FIGS. 13 shows two alternative wiring diagrams of a power supply according to specific embodiments of the invention, wherein each alternative includes eight pairs of control signal sockets 100 and 102, two power input connections 140, and eight independently-controlled power outputs 150.

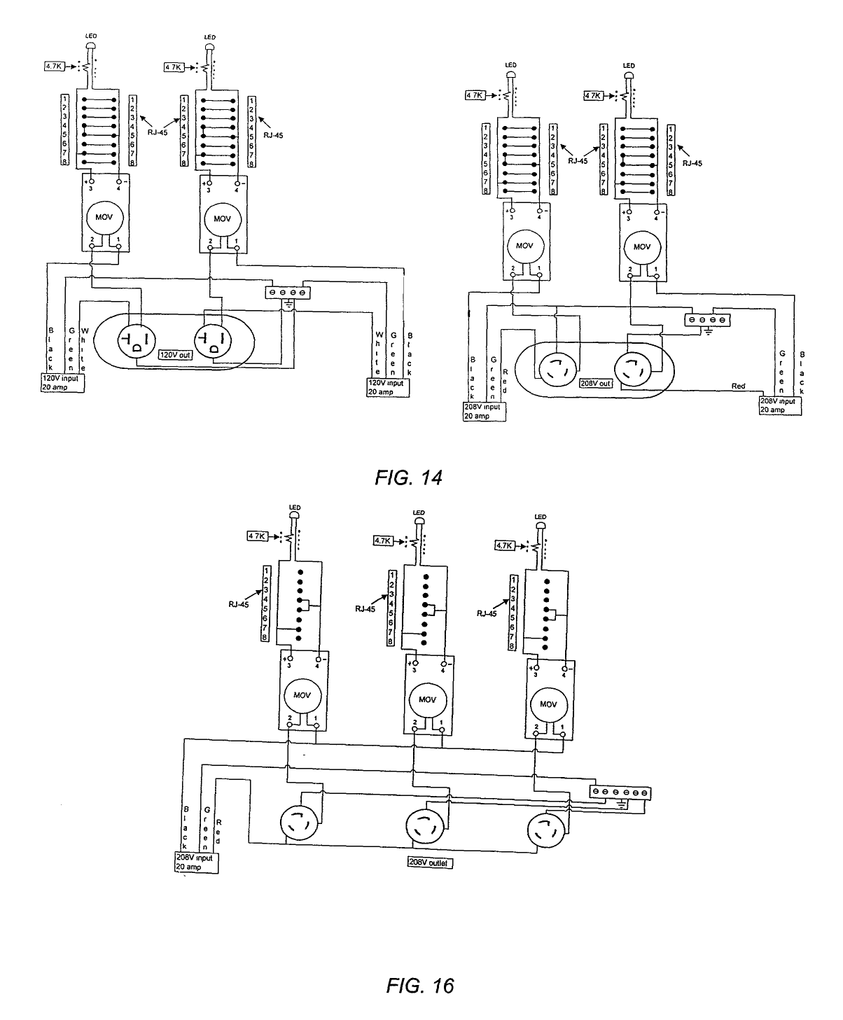

FIG. 14 shows two alternative wiring diagrams of a power supply according to specific embodiments of the invention, wherein each alternative includes two pairs of control signal sockets, two power input connections, and two independently-controlled power outputs.

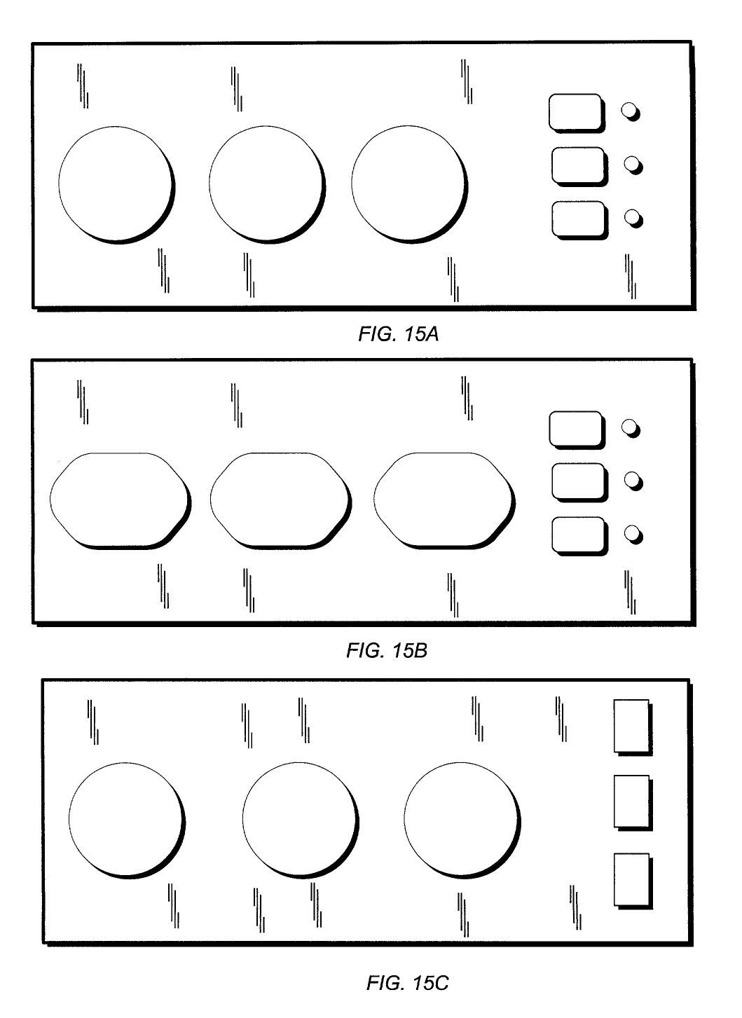

FIGS. 15A-C show alternative top plane views of a alternative power supply wherein there are three independent control sockets and three controlled outputs with various possible arrangements of control signal sockets and controlled outputs.

FIG. 16 shows a wiring diagram of a alternate power supply including three control signal sockets, a power input connection, and three independently-controlled power outputs.

Further Alternative Embodiments

In a further embodiment, recognizing that network equipment is widely used in different parts of the world with different power connections, a power connection is provided via a plug receptacle, which allows for different plug-in plugs. In a further embodiment, the invention can operate with different input power parameters, such as AC power based on a 50 or 60 Mhz cycle and AC power with voltages up to about 300 volts.

Conclusion

The invention has now been explained with regard to specific embodiments. Variations on these embodiments and other embodiments will be apparent to those of skill in the art. The invention therefore should not be limited except as provided in the attached claims. It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A controllable power supply comprising:
a mounting having at least one distinguishable surface;
first and second control signal sockets located on said distinguishable surface for passing through signals received in said first control signal socket out of said second control signal socket;
a controlled power output socket located on one of said distinguishable surfaces;
control circuitry operatively connected with said control signal socket, and said controlled power supply socket wherein power to said controlled power supply socket may be turned on or off in response to a signal received at said control signal socket; and
a power input socket for receiving a detachable power line for connecting to an external power source.

2. The device according to claim 1, further comprising:
an indicator light operatively connected to said control circuitry for indicating whether power to said power supply socket is turned on or off.

3. The device according to claim 1, wherein said control circuitry comprises a control relay.

4. The device according to claim 1 further comprising a housing comprising six surfaces.

5. The device according to claim 4 wherein said housing comprises a top surface, a bottom surface, a front surface, a rear surface, a left surface, and a right surface.

6. The device according to claim 5, wherein said control socket is located on said front surface and said power supply socket is located on said rear surface.

7. The device according to claim 5, wherein said control socket and said power line socket are located on said rear surface.

8. The device according to claim 5 wherein said top surface and said bottom surface are parallel planes between 1.5 and 2.0 inches apart.

9. The device according to claim 6, wherein said power supply is mountable in a computer device rack and occupies only one rack unit.

10. The device according to claim 1 further comprising:
at least two pairs of control sockets, each pair associated with one or more independently controlled power supply sockets.

11. The device according to claim 1 further comprising:
at least four pairs of control sockets, each pair associated with one or more independently controlled power supply sockets.

12. The device according to claim 1 further comprising: p1 at least eight pairs of control sockets, each pair associated with one or more independently controlled power supply sockets.

13. A method for providing a power-cycle reboot in a rack-mounted computing device comprising:
deploying a single rack unity power supply wherein sockets and control circuitry may be contained within a housing having a constrained height;
placing a pair of control signal sockets on a surface of said housing;
placing a controlled power supply outlet on a surface of said housing; and
placing control circuitry within said housing, said control circuitry operatively connected with said pair of control signal sockets and said power supply socket wherein power to said power supply socket may be turned on or off in response to a signal passed through said pair of control signal sockets.

14. A method according to claim 13 further comprising:
providing an input supply socket for accepting a detachable power line for connection to an external power source.

15. A method according to claim 13 further comprising:
providing an input supply socket for accepting a detachable power line.

16. A method according to claim 13 further comprising:
placing said control sockets on a first surface of said housing;
and placing said output sockets on a second surface of said housing.

17. A method according to claim 13 further comprising:
placing said control sockets and said output sockets on a surface of said housing arranged to align with a computing device for which a power cycle reboot is being provided.

18. A method according to claim 13 further comprising:
providing an indicator for each pair of control signal sockets or for each controlled output indicating whether power is supplied to an output.

19. A controllable power supply comprising:
a housing of six surfaces occupying one rack unit;
at least one pair of RJ-45 network connector jacks for routing a network connection through said power supply and reading a control signal therefrom;
a relay responsive to said control signal operationally connected between an external power source connection and a controlled power output such that when a correct signal is routed through said pair of RJ-45 jacks, power is selectively supplied to said output.

20. The device according to claim 19 wherein a control signal is input on 7 of one of said RJ-45 jacks.
